(19) United States
(12) Patent Application Publication
(10) Pub. No.: US 2002/0161631 A1
(43) Pub. Date: Oct. 31, 2002

(54) Methods for e-coupon extension

(75) Inventors: Dwip N. Banerjee, Austin, TX (US); Rabindranath Dutta, Austin, TX (US)

Correspondence Address: STREETS & STEELE, 13831 NORTHWEST FREEWAY, SUITE 355, HOUSTON, TX, 77040, US

(73) Assignee: INTERNATIONAL BUSINESS MACHINES CORPORATION, ARMONK, NY

(21) Appl. No.: 09/821,080

(22) Filed: Mar. 29, 2001

(51) Int. Cl. G06F 17/60

(52) U.S. Cl. 705/14

(57) ABSTRACT

A method for redeeming e-coupons beyond their expiration. The method comprises: maintaining an e-coupon database that comprises an e-coupon identifier, an e-coupon expiration condition such as an expiration date, and a post-expiration instruction; receiving a request to redeem the e-coupon associated with the e-coupon identifier when the e-coupon is expired; and executing the post-expiration instruction associated with the e-coupon identifier. Preferably, the request to redeem an e-coupon is received from a consumer using a graphical user interface. A preferred post-expiration instruction is selected from the group consisting of rejecting the e-coupon, fully redeeming the e-coupon, partially redeeming the e-coupon, issuing an alternative e-coupon for the same product or a substitute product, and combinations thereof.

### BACKGROUND OF THE INVENTION

1. Field of the Invention

The present invention relates to methods for processing e-coupons.

2. Description of the Related Art

Paper coupons are often distributed to potential consumers through newspapers, magazines and direct mailings. The potential consumer collects the coupons and redeems the coupons at the time of purchasing a product or service at a store. However, paper coupons can be costly to print and distribute, especially considering that a great percentage of the paper coupons may never be seen or used by a consumer.

The need for a more efficient and economical coupon distribution system has lead to the use of e-coupons distributed over a global computer network, such as the Internet. Systems and methods for electronically distributing coupons will typically include a host computer that is accessible to potential consumers over a network. The potential consumer uses a personal computer to connect to the host computer or an intermediary computer and download desired coupons for printing and redeeming.

A variety of methods have been proposed for securing the host computer or server that manages the e-coupons, preventing unauthorized duplication of e-coupons, and gathering consumer preferences as indicated by the use of e-coupons. Entire web sites have been developed that are dedicated to delivering e-coupons or directing potential consumers to sites that are offering e-coupons. These sites may allow for direct downloading or e-mail delivery of e-coupons.

Despite the recent development of electronic distribution of coupons, there remains a need to more effectively target consumers that will utilize the coupons. More particularly, there is a need for an improved e-coupon server and method for encouraging use of coupons. It would be desirable for the improved e-coupon server and method to provide more dynamic features to e-coupons, rather than simply mimicking the physical distribution and redemption process.

### SUMMARY OF THE INVENTION

The present invention provides a method comprising: maintaining an e-coupon database that comprises an e-coupon identifier, an e-coupon expiration condition such as an expiration date, and a post-expiration instruction; receiving a request to redeem the e-coupon associated with the e-coupon identifier when the e-coupon is expired; and executing the post-expiration instruction associated with the e-coupon identifier. Preferably, the request to redeem an e-coupon is received from a consumer using a graphical user interface. Furthermore, the e-coupon may be issued from an e-coupon server.

A preferred post-expiration instruction is selected from the group consisting of rejecting the e-coupon, fully redeeming the e-coupon, partially redeeming the e-coupon, issuing an alternative e-coupon for the same product or a substitute product, and combinations thereof. In one embodiment, the e-coupon database further comprises an estimated value of the coupon, and the post-expiration instruction comprises issuing an alternative e-coupon with an estimated value in proportion to the expired e-coupon. Optionally, the method may further comprise executing the post-expiration instruction only if one or more transaction conditions are true, wherein the one or more transaction conditions may include existence of a characteristic of a consumer profile, such as whether the consumer is a return consumer.

The invention also provides an e-coupon server comprising: means for maintaining an e-coupon database, wherein the e-coupon database comprises an e-coupon identifier, an e-coupon expiration condition, and a post-expiration instruction; means for receiving a request to redeem the e-coupon associated with the e-coupon identifier; and means for executing the post-expiration instruction associated with the e-coupon identifier. It is preferred that the e-coupon server further comprise means for issuing an e-coupon from an e-coupon server.

Finally, the invention provides a system comprising: a memory device having a database therein for maintaining information relating to a plurality of e-coupons, the information comprising an expiration condition and post-expiration instructions; and a processor in communication with the memory device. The processor is configured to receive a consumer request to redeem one or more of the plurality of e-coupons that are shown by the database to be expired and execute post-expiration instructions associated with the one or more expired e-coupons. Optionally, the processor may be further configured to issue a substitute e-coupon to the consumer and to redeem the substitute e-coupon upon receipt from the consumer. In one embodiment, the post-expiration instructions are to redeem the e-coupon despite expiration. The processor of the invention maybe further configured to calculate the discount value of the expired e-coupon to the consumer and apply the discount value to a different product.

The foregoing and other objects, features and advantages of the invention will be apparent from the following more particular description of a preferred embodiment of the invention, as illustrated in the accompanying drawing wherein like reference numbers represent like parts of the invention.

### BRIEF DESCRIPTION OF THE DRAWINGS

FIG. 1 is a structural diagram of a distributed data processing system illustrating the relationship of an e-coupon server with e-coupon consumers or clients.

FIG. 2 illustrates a client communicating with a server to redeem e-coupons in accordance with a database located on the server according to the present invention.

FIG. 3 illustrates an example of a client-server system connected through a network.

FIG. 4 is a flowchart showing the main functions or steps in a method for post-termination treatment of e-coupons.

FIG. 5 is a table illustrating an exemplary e-coupon database structure.

FIG. 6 is an example of a client computer system in which the present invention may be implemented.

### DETAILED DESCRIPTION

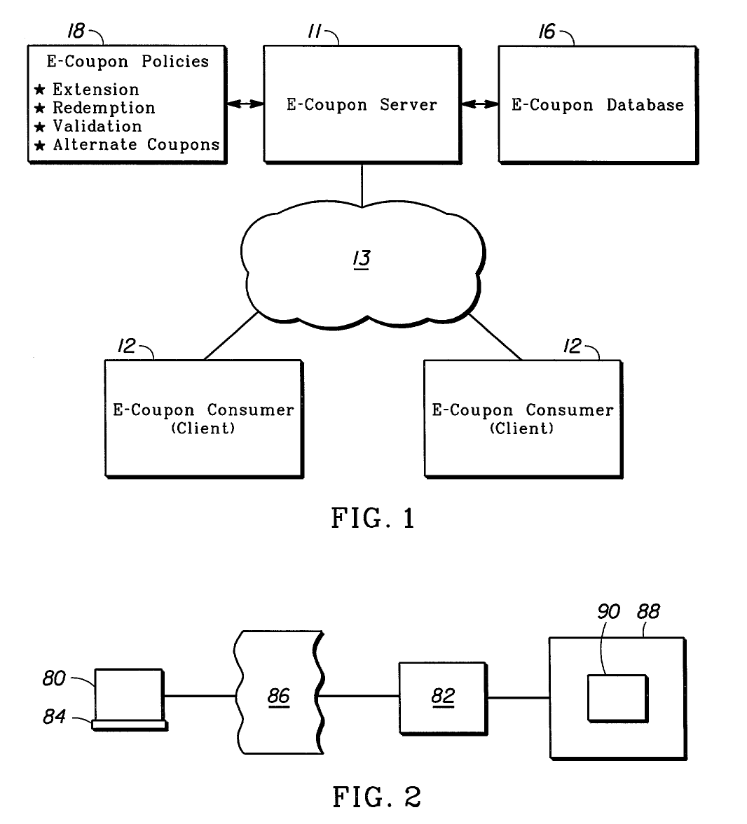

FIG. 1 is a structural diagram of a distributed data processing system 10 illustrating the relationship of an e-coupon server 11 with multiple e-coupon clients or consumers 12 for communication over a communications system or network 13, such as the Internet. The e-coupon server 10 of the present invention includes an e-coupon database 16 and an e-coupon policies database 18 containing instructions for handling e-coupons. The e-coupon clients 12 access the e-coupon server 10 through the communications system 14. A preferred e-coupon client system 12 is shown in more detail in FIG. 6.

Network 13 is the medium used to provide communications links between various devices and computers connected together within distributed data processing system 10. Network 13 may include permanent connections, such as wire or fiber optic cables, or temporary connections made through telephone or wireless communications. Clients and servers may be represented by a variety of computing devices, such as mainframes, personal computers, personal digital assistants (PDAs), smart phones, etc. Distributed data processing system may include additional servers, clients, routers and other devices not shown. In the depicted example, the distributed data processing system 10 may include the Internet with network 13 representing a worldwide collection of networks and gateways that use the TCP/IP suite of protocols to communicate with one another. Of course, the distributed data processing system may also include a number of different types of networks, such as, for example, an intranet, a local area network (LAN), or a wide area network (WAN).

The present invention could be implemented on a variety of hardware platforms and could be implemented in a variety of software environments. A typical operating system may be used to control program execution within the data processing system. Furthermore, although the preferred embodiment described below includes a “browser” at the client as the agent which exchanges data in the security protocols with the Web Application Server, the agent at the client does not have to be a conventional browser, e.g., Netscape Navigator® or Microsoft Internet Explorer®. In order to secure the information transmitted to and from the server, the client may be capable of Public Key Infrastructure (PKI) technology exchanged in a security protocol such as the Secure Sockets Layer (SSL) version 3.0 and above.

Web application server 11 includes a conventional server software program such as Internationl Business Machines' Websphere®, for administering the e-coupon content. The server software includes application programs that enable the server 11 to manage the e-coupon database and execute e-coupon post-expiration policies or instructions in response to redemption requests from the various clients 12.

FIG. 2 is an example of a client attempting to redeem an e-coupon by accessing a server according to the present invention. As illustrated, the user at a client workstation 80 seeks access over a computer network 86 to an e-coupon record 90 located in a database 88 on a server 82 through the user's web browser 84. The computer network 86 may be the Internet, an intranet, or other network. Server 82 may be a Web Application Server (WAS) such as WAS 11 shown in FIG. 1, a server application, a servlet process or the like. Optionally, client 80 submits the required user information to identify themselves as being authorized to access the requested information. User information can include data such as a password or a combination of a user identification and password assigned by the server 82. Web server 82 generates a graphical user interface that is displayed by the browser 84 providing the individual options to the client.

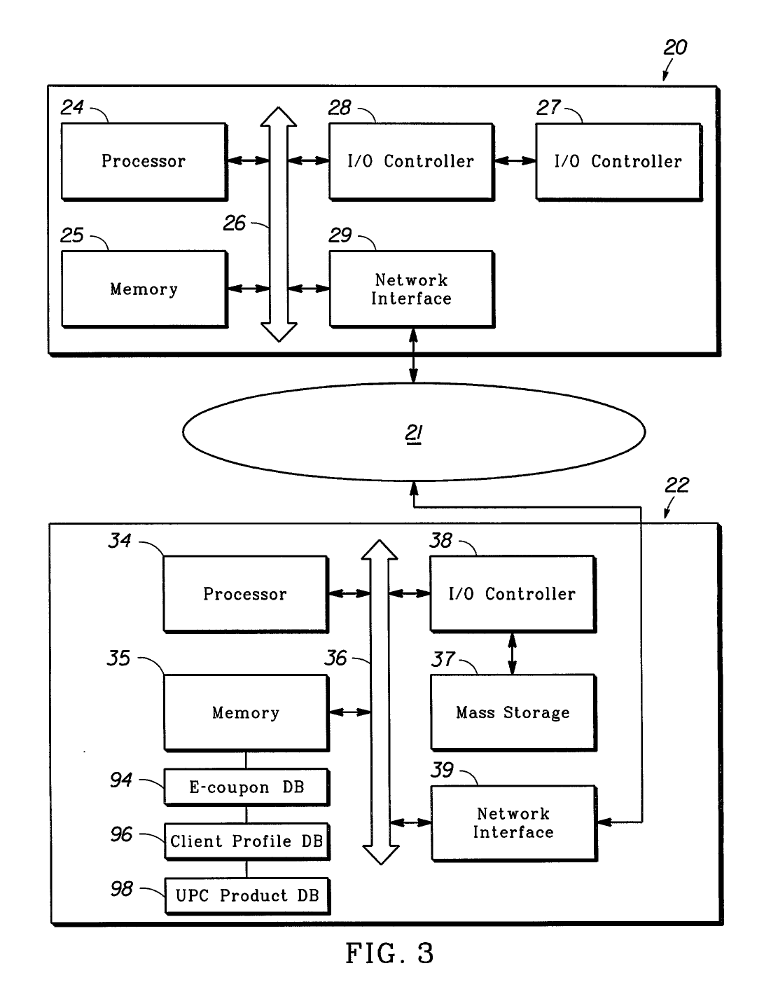

FIG. 3 depicts an example of a client-server system connected through the Internet 21. In this example, a remote server system 22 is connected through the Internet to client system 20. The client system 20 includes conventional components such as a processor 24, memory 25 (e.g. RAM), a bus 26 which couples the processor 24 and memory 25, a mass storage device 27 (e.g. a magnetic hard disk or an optical storage disk) coupled to the processor and memory through an I/O controller 28 and a network interface 29, such as a conventional modem. The server system 22 also includes conventional components such as a processor 34, memory 35 (e.g. RAM), a bus 36 which couples the processor 34 and memory 35, a mass storage device 37 (e.g. a magnetic or optical disk) coupled to the processor 34 and memory 35 through an I/O controller 38 and a network interface 39, such as a conventional modem. It will be appreciated from the description below that the present invention may be implemented in software that is stored as executable instructions on a computer readable medium on the client and server systems, such as mass storage devices 27 and 37 respectively, or in memories 25 and 35 respectively. The server system 22 is shown having an e-coupon database 94, client profile database 96 and UPC product database 98 stored in memory 35. The server 22 is thus suitable for processing: (1) e-coupon identification, (2) calculation of terms, (3) determination of expiration, and (4) carrying out post-expiration instructions. The server 22 also preferably includes electronic mail software for processing e-mail messages and storing e-mail messages transmitted between the server and the various clients.

The server and systems shown in FIGS. 1-3 are suitable for distribution of e-coupons as well as redemption of e-coupons. Methods and systems for distribution of e-coupons are disclosed in U.S. Pat. Nos. 5,907,830 and 6,012,038 which are incorporated by reference herein. The methods and systems of the present invention for redeeming e-coupons will be discussed in more detail below.

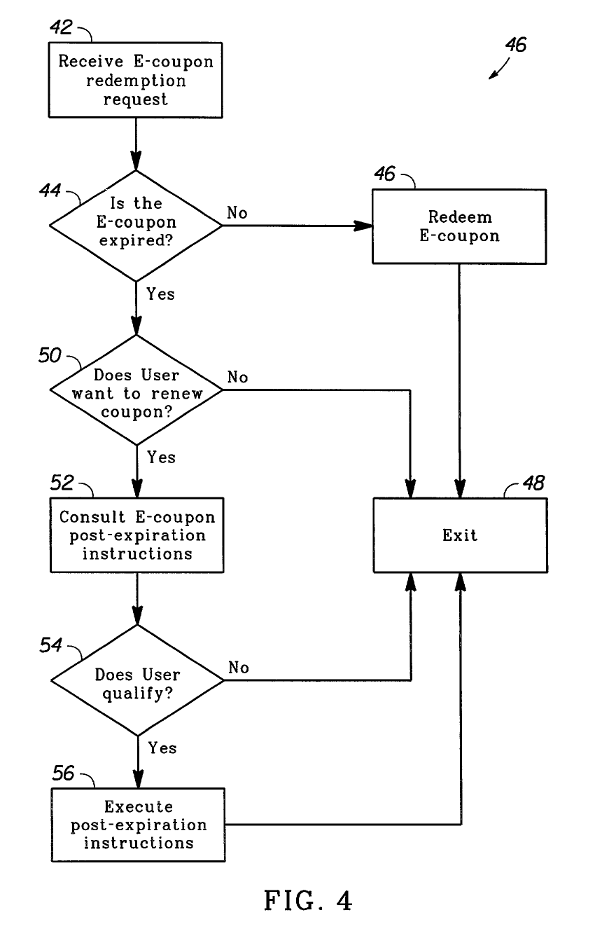

FIG. 4 is a flowchart showing the main functions or steps in a method 40 for redeeming e-coupons. The e-coupon server receives a request from a client or consumer to redeem and e-coupon in step 42, which submission and the details of the submission, including a coupon identifier, are reported directly or indirectly to the e-coupon server. The e-coupon server maintains an e-coupon database 94 that comprises an e-coupon identifier, an e-coupon expiration condition, and a post-expiration instruction. Upon receiving the request, the e-coupon server looks up the identified e-coupon in the e-coupon database to determine whether the e-coupon has expired in step 44. If the e-coupon has not expired, then the e-coupon is redeemed in step 46 in accordance with usual terms of the coupon and in the usual manner. Upon redemption of the e-coupon, the consumer may then exit the server in step 48. However, if the e-coupon has in fact expired, then the consumer is prompted to answer whether they want to renew or replace the coupon in step 50. If the consumer does not choose to renew or replace the coupon, then the consumer may exit the server in step 48.

If the consumer chooses to renew or replace the coupon in step 50, then the e-coupon server executes the post-expiration instruction associated with the e-coupon identifier in step 52. The post-expiration policies preferably include post-expiration instructions and post-expiration qualifications. If it is determined in step 54 that certain conditions, such as the profile of the consumer submitting the e-coupon, do not meet the qualifications set out in the post-expiration policies, then the consumer may exit in step 48. However, if the consumer does qualify under the post-expiration policies, then the post-expiration instructions are carried out in step 56, for example by redeeming the e-coupon despite expiration or by issuing a substitute e-coupon.

The present invention provides a substantial benefit to e-coupon issuers, such as manufacturers, distributors, retailers and the like, by allowing them the option to customize their response to a consumer, at perhaps the last step in a purchasing transaction, when a coupon is tendered that has expired. Receiving or downloading an e-coupon for a given product, deciding to purchase the given product, accessing a vendor to purchase the given product, and submitting the e-coupon must all occur prior to the step of actually redeeming the coupon. Consequently, the consumer is at that point in time a ready, willing and able purchaser at the point of sale. The supplier or manufacturer of the product, or perhaps even the operator of the e-coupon server, may desire to reward the consumer for going through the purchasing process and getting to this point by issuing post-expiration instructions. Otherwise, the nature result of the situation where a consumer tenders an expired coupon is that the consumer is disappointed, rethinks the purchasing decision, becomes disenchanted with the coupon redemption process, and the like. Each of these latter outcomes is a setback for the e-coupon issuer who is striving to earn consumer loyalty.

It should be recognized that the present invention provides for the possibility of a dynamic e-coupon that can function in a variety of new ways. For example, the expiration of a coupon is typically governed by whether or not the present date is later in time than an expiration date stated on the face of the coupon. However, according to the present invention, it is possible that a coupon could expire following a fixed number of redemptions (i.e., the first 1,000 consumers) or any other condition that would encourage the consumer to promptly redeem the coupon.

A dynamic e-coupon also provides unlimited opportunities to take action at the point of sale in accordance with a set of predetermined criteria. For example, post-expiration instructions might include: (1) replacing the expired e-coupon with the best coupon available for the product, (2) replacing the expired e-coupon with a coupon of similar value toward a substitute product, such as that offered by a competitive brand, (3) redeeming the expired e-coupon at a declining value over a period of time following the stated expiration date, (4) replacing the expired e-coupon with a coupon for an upgraded product at less than the full difference in the cost, or perhaps merely suggesting a generic equivalent that is already at a reduced price. A dynamic e-coupon might even provide the consumer with choices between two or more post-expiration options. Accordingly, any of the terms of sale—product, discount terms, expiration date—can be adjusted in accordance with the predetermined criteria.

Even the determination of consumer qualifications for the post-expiration policies may be dynamic. In fact, the consumer qualifications may indicate that all consumers qualify, such as if the qualification is based on non-consumer information, such as inventory levels. Examples of suitable qualifications might include: (1) consumer profile information, such as frequency of coupon redemption, (2) volume or price of the product for which the coupon is being redeemed, (3) total sale amount for the consumer at the time of checkout, (4) inventory levels of the product for which the coupon is being redeemed, and (5) time of day or day of the week, such as periods of slow business activity at the point of redemption. Accordingly, any of the conditions surrounding the consumer of supplier can be used to form a predetermined criteria for qualifying the consumer.

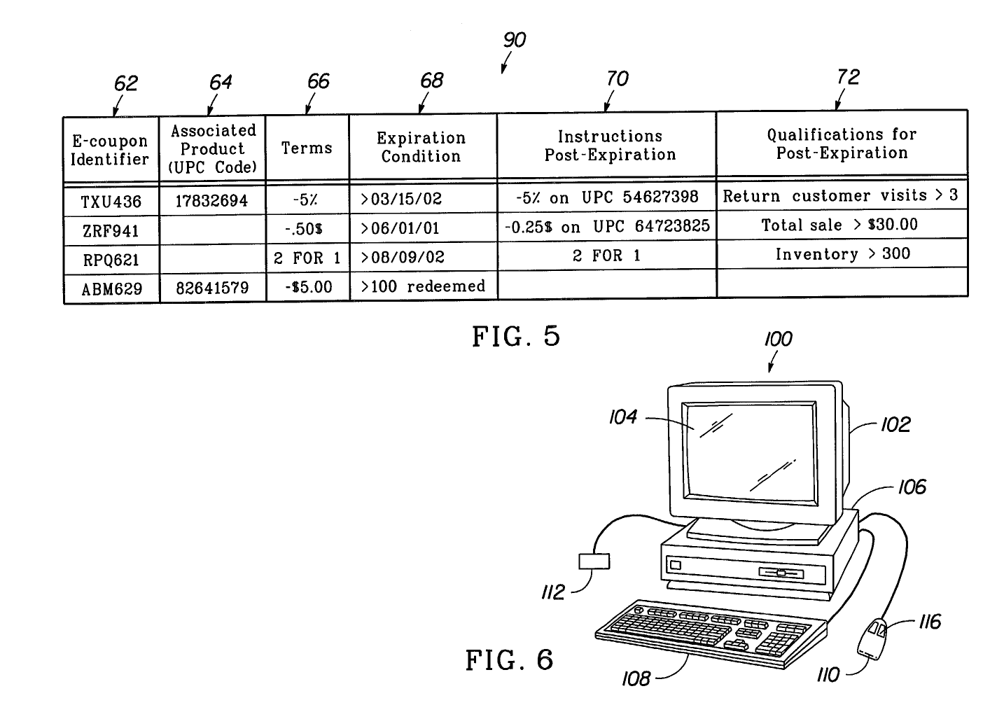

FIG. 5 is a table illustrating an exemplary e-coupon database structure 60. The database 60 is shown wherein each e-coupon comprises a record, each record having separate fields for: (1) an e-coupon identifier 62, (2) a code 64, such as the UPC code, for the product associated with the e-coupon, (3) the coupon terms 66, such as percentage or fixed amount discounts, (4) an expiration condition 68, such as a date or redemption volume, (5) post-expiration instructions 70, and (6) post-expiration qualifications 72.

The e-coupon database 60 must be configured or updated periodically to reflect registration of new e-coupon identifiers 62 and the associated e-coupon record, updating of post-expiration instructions, removal of old e-coupon records, and the like. This configuring is preferably performed by directly accessing the e-coupon server through a graphical user interface using a mouse, keyboard or uploading files from another computer. Alternatively, the e-coupon server and the e-coupon database may be accessed over the Internet or other network connection by the advertiser in order to maintain the information their database records. Advertiser access to the database should be restricted by a common security system, for example requiring correct input of a pre-registered username and password.

FIG. 6 shows a client computer system 100 that can run a browser. The computer system 100 includes a display device 102 (such as a monitor), a display screen 104, a cabinet 106 (which encloses components typically found in a computer, such as CPU, RAM, ROM, video card, hard drive, sound card, serial ports, etc.), a keyboard 108, a mouse 110 and a modem 112. Mouse 110 may have one or more buttons, such as buttons 116. The computer requires some type of communication device such as modem 112 that allows computer system 100 to be connected to the Internet. Other possible communication devices include ethernet network cards.

It will be understood from the foregoing description that various modifications and changes may be made in the preferred embodiment of the present invention without departing from its true spirit. It is intended that this description is for purposes of illustration only and should not be construed in a limiting sense. The scope of this invention should be limited only by the language of the following claims.

What is claimed is:

1. A method comprising:
maintaining an e-coupon database that comprises an e-coupon identifier, an e-coupon expiration condition, and a post-expiration instruction;
receiving a request to redeem the e-coupon associated with the e-coupon identifier when the e-coupon is expired; and
executing the post-expiration instruction associated with the e-coupon identifier.

2. The method of claim 1, further comprising issuing the e-coupon from an e-coupon server.

3. The method of claim 2, further comprising configuring the e-coupon server through a graphical user interface.

4. The method of claim 1, wherein the post-expiration instruction is selected from the group consisting of rejecting the e-coupon, fully redeeming the e-coupon, partially redeeming the e-coupon, issuing an alternative e-coupon, and combinations thereof.

5. The method of claim 1, wherein the post-expiration instruction comprises issuing an alternative e-coupon for a product selected from the same product and a substitute product.

6. The method of claim 1, wherein the e-coupon database further comprises an estimated value of the coupon, and wherein the post-expiration instruction comprises issuing an alternative e-coupon with an estimated value in proportion to the expired e-coupon.

7. The method of claim 1, wherein the expiration condition is an expiration date.

8. The method of claim 1, further comprising:
executing the post-expiration instruction only if one or more transaction conditions are true.

9. The method of claim 8, wherein the one or more transaction conditions includes existence of a characteristic of a consumer profile.

10. The method of claim 9, wherein the characteristic of the consumer profile is whether the consumer is a return consumer.

11. The method of claim 1, wherein the request to redeem an e-coupon is received from a consumer using a graphical user interface.

12. An e-coupon server, comprising:
maintaining means for maintaining an e-coupon database, wherein the e-coupon database comprises an e-coupon identifier, an e-coupon expiration condition, and a post-expiration instruction;
receiving means for receiving a request to redeem the e-coupon associated with the e-coupon identifier; and
executing means for executing the post-expiration instruction associated with the e-coupon identifier.

13. The e-coupon server of claim 12, further comprising:
issuing means for issuing an e-coupon from an e-coupon server.

14. The e-coupon server of claim 12, further comprising:
a graphical user interface for configuring the e-coupon server.

15. The e-coupon server of claim 12, wherein the post-expiration instruction is selected from the group consisting of rejecting the e-coupon, fully redeeming the e-coupon, partially redeeming the e-coupon, issuing an alternative e-coupon, and combinations thereof.

16. The e-coupon server of claim 12, wherein the post-expiration instruction comprises issuing an alternative e-coupon for a product selected from the same product and a substitute product.

17. The e-coupon server of claim 12, wherein the e-coupon database further comprises estimating means for estimating the value of the coupon, and wherein the post-expiration instruction comprises issuing means for issuing an alternative e-coupon with an estimated value in proportion to the expired e-coupon.

18. The e-coupon server of claim 12, wherein the expiration condition is an expiration date.

19. The e-coupon server of claim 12, further comprising:
executing means for executing the post-expiration instruction only if one or more transaction conditions are true.

20. The e-coupon server of claim 19, wherein the one or more transaction conditions includes existence of a characteristic of a consumer profile.

21. The e-coupon server of claim 20, wherein the characteristic of the consumer profile is whether the consumer is a return consumer.

22. The e-coupon server of claim 12, wherein the request to redeem an e-coupon is received from a consumer using a graphical user interface.

23. A system comprising:
a memory device having a database therein for maintaining information relating to a plurality of e-coupons, the information comprising an expiration condition and post-expiration instructions;
a processor in communication with the memory device, the processor configured to:
receive a consumer request to redeem one or more of the plurality of e-coupons that are shown by the database to be expired;
execute post-expiration instructions associated with the one or more expired e-coupons.

24. The system of claim 23, wherein the processor is further configured to:
issue a substitute e-coupon to the consumer.

25. The system of claim 24, wherein the processor is further configured to:
redeem the substitute e-coupon upon receipt from the consumer.

26. The system of claim 23, wherein the post-expiration instructions are to redeem the e-coupon despite expiration, and wherein the processor is further configured to:
redeem the e-coupon.

27. The system of claim 23, wherein the processor is further configured to:
calculate the discount value of the expired e-coupon to the consumer; and
apply the discount value to a different product.

28. A computer program product including instructions embodied on a computer readable medium, the instructions comprising:
maintaining instructions for maintaining an e-coupon database that comprises an e-coupon identifier, an e-coupon expiration condition, and a post-expiration instruction;
receiving instructions for receiving a request to redeem the e-coupon associated with the e-coupon identifier when the e-coupon is expired; and
executing instructions for executing the post-expiration instruction associated with the e-coupon identifier.

29. The computer program product of claim 28, further comprising:
issuing instructions for issuing the e-coupon from an e-coupon server.

30. The computer program product of claim 29, further comprising:
configuring instructions for configuring the e-coupon server through a graphical user interface.

31. The computer program product of claim 28, wherein the post-expiration instruction is selected from the group consisting of rejecting the e-coupon, fully redeeming the e-coupon, partially redeeming the e-coupon, issuing an alternative e-coupon, and combinations thereof.

32. The computer program product of claim 28, wherein the post-expiration instruction comprises issuing instructions for issuing an alternative e-coupon for a product selected from the same product and a substitute product.

33. The computer program product of claim 28, wherein the e-coupon database further comprises an estimated value of the coupon, and wherein the post-expiration instruction comprises issuing instructions for issuing an alternative e-coupon with an estimated value in proportion to the expired e-coupon.

34. The computer program product of claim 28, wherein the expiration condition is an expiration date.

35. The computer program product of claim 28, further comprising:
executing instructions for executing the post-expiration instruction only if one or more transaction conditions are true.

36. The computer program product of claim 36, wherein the one or more transaction conditions includes the existence of a characteristic of a consumer profile.

37. The computer program product of claim 36, wherein the characteristic of the consumer profile is whether the consumer is a return consumer.

38. The computer program product of claim 28, wherein the request to redeem an e-coupon is received from a consumer using a graphical user interface.
